(19) United States
(12) Patent Application Publication
(10) Pub. No.: US 2014/0282620 A1
(43) Pub. Date: Sep. 18, 2014

(54) SYSTEM AND METHOD FOR TRIGGERING AN EVENT IN RESPONSE TO RECEIVING A DEVICE IDENTIFIER

(71) Applicants: Frank Settemo NUOVO, Los Angeles, CA (US); Antonio Conrad NUOVO, Los Angeles, CA (US); Richard James ASHALL, Wokingham (GB); Gerardo HERRERA, Agoura Hills, CA (US); Bruce Jay GREENBAUM, Los Angeles, CA (US)

(72) Inventors: Frank Settemo NUOVO, Los Angeles, CA (US); Antonio Conrad NUOVO, Los Angeles, CA (US); Richard James ASHALL, Wokingham (GB); Gerardo HERRERA, Agoura Hills, CA (US); Bruce Jay GREENBAUM, Los Angeles, CA (US)

(21) Appl. No.: 13/842,454

(22) Filed: Mar. 15, 2013

(51) Int. Cl. G06F 9/54

(52) U.S. Cl. CPC G06F 9/542
USPC 719/318

(57) ABSTRACT

A process implemented method operating on a processor of a mobile device. The method can include detecting an advertised device identifier and comparing the detected device identifier with device identifiers stored on the mobile device. If there is a match, the match can trigger an event. The event can be requesting content associated with the matched device identifier, receiving the requested content, and rendering the received content. The requested content can be selected to have additional, corresponding content downloaded and rendered.

The present technology relates to a system and method for triggering an event in response to receiving a device identifier. More specifically, the present technology relates to a system and method that searches, detects, and matches advertised device identifiers and rendering content associated with one or more matched device identifiers.

### BACKGROUND

Mobile devices are becoming more prevalent and more advanced. Such advances include WiFi and Bluetooth capabilities. For example, mobile devices can connect to the Internet via WiFi and can connect to the microphone and speakers in an automobile via Bluetooth. In some instances, the mobile device may need to scan for a WiFi hotspot in order to connect to the internet. For example, the mobile device may scan for broadcasted signals of an available WiFi network and select a WiFi hotspot. Similarly, in order to use Bluetooth in a vehicle, the mobile device has to link to the Bluetooth system in the vehicle. As WiFi and Bluetooth technology advance, mobile device users will be able to leverage these technologies for non-traditional uses.

### BRIEF DESCRIPTION OF THE DRAWINGS

Implementations of the present technology will now be described, by way of example only, with reference to the attached figures, wherein:

FIG. 1 is a block diagram of a content delivering system in accordance with an exemplary embodiment;

FIG. 2 (comprising 2A and 2B) is a flowchart of a method for delivering content to a mobile device having limited download capability in accordance with an exemplary embodiment;

FIG. 3 (comprising 3A and 3B) is a flowchart of a method for delivering content to a mobile device having high download capability in accordance with an exemplary embodiment;

FIG. 4 (comprising 4A and 4B) is a flowchart of a method for delivering content to a mobile device using an on-line capability in accordance with an exemplary embodiment;

FIG. 5 is a flowchart of a method for using content messaging at a point of purchase in accordance with an exemplary embodiment;

FIG. 6 is a flowchart of an alternate method for using content messaging at a point of purchase in accordance with an exemplary embodiment;

FIG. 7 is a flowchart for a method for using content messaging for protecting property in accordance with an exemplary embodiment;

FIG. 8 is a flowchart of an alternate method for using content messaging for protecting property in accordance with an exemplary embodiment;

FIG. 9 is a flowchart of a method for using double authentication to protect property in accordance with an exemplary embodiment;

FIG. 10 is a flowchart of a method for discovery and content messaging in accordance with an exemplary embodiment;

FIG. 11 is a flowchart of a method for discovery and content messaging in accordance with an exemplary embodiment;

FIG. 12 is a flowchart of a method for server logging in accordance with an exemplary embodiment;

FIG. 13 is a flowchart of an alternate method for server logging in accordance with an exemplary embodiment;

FIG. 14 is a flowchart of a method for rewarding customer loyalty in accordance with an exemplary embodiment;

FIG. 15 is a flowchart for a method for product rental and return in accordance with an exemplary embodiment;

FIG. 16 is a flowchart of a method for visit counting and timing in accordance with an exemplary embodiment;

FIG. 17 is a flowchart of an alternate method for counting and timing content messaging method in accordance with an exemplary embodiment;

FIG. 18 is a block diagram of a category selection screenshot in accordance with an exemplary embodiment;

FIG. 19 is a category selection screenshot in accordance with an exemplary embodiment;

FIG. 20 is a block diagram of a homepage screenshot in accordance with an exemplary embodiment;

FIG. 21 is a block diagram of a homepage screenshot with a displayed menu in accordance with an exemplary embodiment;

FIG. 22 is a homepage screenshot with a displayed menu in accordance with an exemplary embodiment;

FIG. 23 is a block diagram of a screenshot of a header page in accordance with an exemplary embodiment;

FIG. 24 is a screenshot of a header page in accordance with an exemplary embodiment;

FIG. 25 is a block diagram of a screenshot of a content page in accordance with an exemplary embodiment;

FIG. 26 is a screenshot of a content page in accordance with an exemplary embodiment;

FIG. 27 is a block diagram of a screenshot of a collections page in accordance with an exemplary embodiment; and

FIG. 28 is a screenshot of a collections page in accordance with an exemplary embodiment is illustrated.

### DETAILED DESCRIPTION

For simplicity and clarity of illustration, where appropriate, reference numerals have been repeated among the different figures to indicate corresponding or analogous elements. In addition, numerous specific details are set forth in order to provide a thorough understanding of the implementations described herein. However, those of ordinary skill in the art will understand that the implementations described herein can be practiced without these specific details. In other instances, methods, procedures and components have not been described in detail so as not to obscure the related relevant feature being described. Also, the description is not to be considered as limiting the scope of the implementations described herein.

Several definitions that apply throughout this disclosure will now be presented. The phrase “coupled” is defined as connected, whether directly or indirectly through intervening components, and is not necessarily limited to physical connections. For example, coupled devices can include devices which are in signal communication with one another. The term “communicatively coupled” is defined as connected, whether directly or indirectly through intervening components, is not necessarily limited to a physical connection, and allows for the transfer of data.

The term “memory” refers to transitory memory and non-transitory memory. For example, non-transitory memory can be implemented as Random Access Memory (RAM), Read-Only Memory (ROM), flash, ferromagnetic, phase-change memory, and other non-transitory memory technologies. The term “medium” refers to memory or a storage device. The medium can be transitory or non-transitory. In one specific example the medium includes tangible and/or non-transitory storage medium for carrying or having processor executable instructions or data structures stored thereon. Such non-transitory storage medium can be any available medium that can be accessed by a general processor or special purpose processor. By way of example, and not limitation, such non-transitory medium can include RAM, ROM, EEPROM, CD-ROM or other optical disk storage, magnetic disk storage or other magnetic storage devices, or any other medium which can be used to carry or store processor-executable instructions or data structures. When information is transferred or provided over a network or another communications connection (either hardwired, wireless, or combination thereof) to a processor, the processor properly views the connection as a processor-readable medium. Thus, any such connection is properly termed a processor-readable medium. Combinations of the above should also be included within the scope of the processor-readable medium.

The term “application server” is defined as one or more hardware devices or software component that is configured to execute instructions or is a set of instructions residing on one or more hardware components. An “application” is computer software that is designed to help the user perform specific tasks. An application includes instructions that can be executed by a mobile device. For example, a processor of the mobile device can execute instructions for the application. Additionally, the application can be stored on a storage medium including memory. Processor-executable instructions include, for example, instructions and data which cause a general purpose computer, special purpose computer, or special purpose processing device to perform a certain function or group of functions. Processor-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Processor-executable instructions, associated data structures, and program modules represent examples of the program code means for executing steps of the methods disclosed herein. The particular sequence of such executable instructions or associated data structures represents examples of corresponding acts for implementing the functions described in such steps.

The present technology is directed to an application that operates on a mobile device. When executed, the application can cause the mobile device to search for device identifiers, e.g., media access controller addresses and/or broadcast identifiers (IDs), which are advertised by wireless beacon units, such as WiFi beacon units and Bluetooth beacon units. The device identifiers can be media access controller addresses and/or broadcast identifiers (IDs). The received device identifiers can be compared with a list of stored device identifiers. Each of the device identifiers in the list can be associated with content. In the event of a match, the mobile device can render the associated content. The mobile device can allow a user to review the associated content, save the associated content, create their own associated content, and share associated content with friends and other users.

Referring to FIG. 1, a block diagram of a content messaging and delivering system in accordance with an exemplary embodiment is illustrated. As shown, the content delivering system 100 can include a mobile device 102, a first wireless beaconing unit 104, a second wireless beaconing unit 106 and a server 108. One of ordinary skill in the art would appreciate that the content delivering system 100 illustrated in FIG. 1 shows single iterations of each component for illustrative purposes, however there can be multiple iterations of one or more of the components. For example, the content delivering system 100 can include multiple mobile devices 102, multiple first wireless beaconing units 104, multiple second wireless beaconing units 106, multiple servers 108 and multiple databases 120. The mobile device 102 can include, but is not limited to, portable communication devices, mobile communication devices, mobile computers, smart phones, computing pads, tablet computers, laptop computers, notebooks, or other electronic devices that are capable of transmitting data, receiving data, executing commands, and include their own power sources. The mobile device 102 can include a processor 110. The processor 110 can be communicatively coupled to one or more of the components of the mobile device 102. For example, the processor 110 can be communicatively coupled to a memory 112. The memory 112 can be RAM, ROM, flash, any other type of memory including transitory and non-transitory memory, or any combination thereof. The memory 112 can include device identifiers and corresponding data. A device identifier can be a media access controller (MAC) address or a broadcast identifier (ID). The device identifiers and corresponding data can be downloaded from a server 108 which is external to the mobile device 102. In one or more embodiments, all communications between the mobile device 102 and the server 108 can go via the secured socket layer (SSL) that encrypts the data. The server 108 can obtain the list of device identifiers and corresponding data from one or more databases 120. In one or more embodiments, the server 108 and/or database 120 can be cloud based. The server 108 can be an application server or an Application Program Interface (API) server.

The mobile device 102 can include one or more antennas 114, 116 for receiving device identifiers advertised by one or more wireless beaconing units 104, 106. For example, the mobile device 102 can include a WiFi antenna 114 for receiving a device identifier advertised by the first wireless beaconing unit 104 and a Bluetooth antenna 116 for receiving a device identifier advertised by a second wireless beaconing unit 106. The first wireless beaconing unit 104 can be a WiFi transmitter, receiver or transceiver. The second wireless beaconing unit 106 can be a Bluetooth transmitter, receiver or transceiver. The mobile device 102 can also use the one or more antennas 114, 116 for transmitting a device identifier associated with the mobile device 102. The wireless beaconing units 104, 106 can be any device that advertises, broadcasts or transmits a device identifier. The wireless beaconing units 104, 106 can also be any device that receives advertised, broadcasted or transmitted device identifiers. In one or more embodiments, the wireless beaconing unit 104, 106 can be a mobile device. For example, a mobile device can advertise a device identifier. In one or more embodiments, the mobile device can operate to broadcast a device identifier via Bluetooth. In such embodiments, the mobile device can broadcast without a SIM card, e.g., using non-cellular service. The processor 110 can be communicatively coupled to the one or more antennas, e.g., WiFi antenna 104 and/or Bluetooth antenna 106, for detecting one or more advertised device identifiers. The processor 110 can compare each detected advertised device identifier with the list of device identifiers stored in memory 112. For each matched device identifier, the processor 110 can obtain content associated with the matched device identifier. In one or more embodiments, the processor 110 can obtain such content from memory 112. In one or more embodiments, the processor 110 can obtain such content from the server 108 which is external to the mobile device 102. The processor 110 can access the server 108 via an antenna 118, such as, but not limited to, a cellular antenna or a WiFi antenna. In one or more embodiments, the WiFi antenna 114 and the antenna 118 can be the same antenna. In one or more embodiments, all communications between the mobile device 102 and the server 108 can go via the secured socket layer (SSL) that encrypts the data. The server 108 can obtain the content associated with the matched device identifier from one or more databases 120. In one or more embodiments, the server 108 and/or database 120 can be cloud based. The server 108 can be communicatively coupled to one or more databases 120. The server 108 can store content associated with each of the mobile identifiers and/or can obtain such content from one or more databases 120. In one or more embodiments, the server 108 and/or database 120 can be cloud based. The server 108 can be an application server or an Application Program Interface (API) server.

Referring to FIG. 2, a flowchart of a method for delivering content to a mobile device having limited download capability in accordance with an exemplary embodiment is illustrated. The exemplary method 200 is provided by way of example, as there are a variety of ways to carry out the method. The method 200 described below can be carried out using the components illustrated in FIG. 1 by way of example, and various elements of these figures are referenced in explaining exemplary method 200. Each block shown in FIG. 2 represents one or more processes, methods or subroutines, carried out in the exemplary method 200. The exemplary method 200 can begin at block 202.

At block 202, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be selectively limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. The user can also select to download only those identifiers and corresponding date for which a contact has been previously been established. Alternatively, a user can also select a particular configuration of device identifiers previously segregated by another person, group or entity. After downloading the device identifiers and corresponding data, the method 200 can proceed to block 204.

At block 204, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 200 can proceed to block 206.

At block 206, a detected advertised device identifier can be stored. For example, the processor 110 can store a detected advertised device identifier in the memory 112. After storing the detected advertised device identifiers, the method 200 can proceed to block 208.

At block 208, the detected advertised device identifier can be compared to the downloaded device identifiers. For example, the processor 110 can compare the detected advertised device identifier to each of the downloaded device identifiers. For a matched device identifier, the method 200 can proceed to block 212. For an unmatched device identifier, the method 200 can proceed to block 210.

At block 210, the unmatched device identifier can be uploaded. For example, the processor 102 can upload the unmatched device identifier to a server 108, e.g., an application server. After uploading the unmatched device identifier, the method 200 can proceed to block 204.

At block 212, the matched device identifier can be uploaded and a notification can be issued. For example, the processor 110 can upload the matched device identifier to a server 108, e.g., an application server, and the processor 110 can issue a notification. The notification can be within the mobile device 102 at the operating system level and/or at the application level. Alternatively, an application of the mobile device 102 can issue a notification. The notification can result in a visual, audible and/or via vibrational notification depending on the settings of the mobile device 102. For example, in response to the issued notification, an application icon in an operating system level and/or in the application level can be displayed, a ring tone can be triggered and/or the mobile device can vibrate to inform the user of the matched device identifier. FIG. 22 shows a homepage 2200 displaying three notifications 2214, 2216, 2218 for three matched device identifiers. After uploading the matched device identifier and issuing a notification, the method 200 can proceed to block 214.

At block 214, a selection of a category associated with a matched device identifier can be received. For example, in response to the application level notification, the processor 110 can render a list of user selected categories and the processor 110 can receive a selection of one of the displayed user selected categories. Referring to FIG. 22 again, the user can select one of the displayed user selected categories, such as the LA Auto Show category 2202. After receiving a selection of a category, the method 200 can proceed to block 216.

At block 216, a determination can be made whether the mobile device is connected to the internet. For example, the processor 110 determines if there is an internet connection. If there is no internet connection, then the method 200 can proceed to block 218. If the determination is that there is an internet connection, then the method 200 can proceed to block 220.

At block 218, locally cached information associated with the selected category can be rendered, if available. For example, the processor 110 determines if there is locally cached information associated with the selected category and renders such information if available.

FIG. 24 shows a header page 2400 displaying three headers 2402, 2404, 2406. In the event that the header page 2400 was stored in the local cache, then the header page 2400 could be displayed.

At block 220, header content associated with the device identifier can be downloaded and rendered. For example, the processor 110 can use the device identifier to download header content associated with the device identifier from a server 108 via the internet. Once the header content is downloaded, the processor 110 can render the header content. Again, FIG. 24 is a screenshot of an exemplary header page 2400. After downloading the header content, the method 200 can proceed to block 222.

At block 222, additional content associated with the device identifier can be downloaded in response to receiving a selection of the previous downloaded content. For example, the processor 110 can download the content associated with the selected header and can display the additional content associated with the selected header. FIG. 26 shows a content page 2600 associated with the selected header 2404 of FIG. 24.

Referring to FIG. 3, a flowchart of a method for delivering content to a mobile device having high download capability in accordance with an exemplary embodiment is illustrated. The exemplary method 300 is provided by way of example, as there are a variety of ways to carry out the method. The method 300 described below can be carried out using the components illustrated in FIG. 1 by way of example, and various elements of these figures are referenced in explaining exemplary method 300. Each block shown in FIG. 3 represents one or more processes, methods or subroutines, carried out in the exemplary method 300. The exemplary method 300 can begin at block 302.

At block 302, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. As above in method 200, other selection variations are also applicable. After downloading the list of device identifiers and corresponding data, the method 300 can proceed to block 304.

At block 304, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 300 can proceed to block 306.

At block 306, a detected advertised device identifier can be stored. For example, the processor 110 can store a detected advertised device identifier in the memory 112. After storing the detected advertised device identifiers, the method 300 can proceed to block 308.

At block 308, the detected advertised device identifier can be compared to the downloaded device identifiers. For example, the processor 110 can compare the detected advertised device identifier to each of the downloaded device identifiers. For a matched device identifier, the method 300 can proceed to block 312. For an unmatched device identifier, the method 300 can proceed to block 310.

At block 310, the unmatched device identifier can be uploaded. For example, the processor 102 can upload the unmatched device identifier to a server 108, e.g., an application server. After uploading the unmatched device identifier, the method 300 can proceed to block 304 for rediscovery opportunity at a later time.

At block 312, the matched device identifier can be uploaded and a notification can be issued. For example, the processor 110 can upload the matched device identifier to a server 108, e.g., an application server, and the processor 110 can issue a notification. Alternatively, an application of the mobile device 102 can issue a notification. The notification can be within the mobile device 102 at the operating system level and/or at the application level. The notification can result in a visual, audible and/or via vibrational notification depending on the settings of the mobile device 102. For example, in response to the issued notification, an application icon in an operating system level and/or in the application level can be displayed, a ring tone can be triggered and/or the mobile device can vibrate to inform the user of the matched device identifier. FIG. 22 shows a homepage 2200 displaying three notifications 2214, 2216, 2218 for three matched device identifiers. After uploading the matched device identifier and issuing a notification, the method 300 can proceed to block 314.

At block 314, a selection of a category associated with a matched device identifier can be received. For example, in response to the application level notification, the processor 110 can render a list of user selected categories and the processor 110 can receive a selection of one of the displayed user selected categories. Referring to FIG. 22 again, the user can select one of the displayed user selected categories, such as the LA Auto Show category 2202. After receiving a selection of a category, the method 300 can proceed to block 316.

At block 316, header content associated with the device identifier can be downloaded and rendered. For example, the processor 110 can use the device identifier to download header content associated with the device identifier from a server 108 via the internet. Once the header content is downloaded, the processor 110 can render the header content. Again, FIG. 24 is a screenshot of an exemplary header page 2400. After downloading the content, the method 300 can proceed to block 318.

At block 318, additional content associated with the device identifier can be downloaded in response to receiving a selection of the previous downloaded content. For example, the processor 110 can download the content associated with the selected header and can display the additional content associated with the selected header. FIG. 26 shows a content page 2600 associated with the selected header 2404 of FIG. 24.

Referring to FIG. 4, a flowchart of a method for delivering content to a mobile device using an on-line capability in accordance with an exemplary embodiment is illustrated. The exemplary method 400 is provided by way of example, as there are a variety of ways to carry out the method. The method 400 described below can be carried out using the components illustrated in FIG. 1 by way of example, and various elements of these figures are referenced in explaining exemplary method 400. Each block shown in FIG. 4 represents one or more processes, methods or subroutines, carried out in the exemplary method 400. The exemplary method 400 can begin at block 402.

At block 402, the mobile device can search for advertised device identifiers. For example, the processor 110 can search for all advertised device identifiers using one or more antennas, e.g., WiFi antenna 104 and/or Bluetooth antenna 106. After searching for advertised device identifiers, the method 400 can proceed to block 404.

At block 404, an advertised device identifier can be detected. For example, the processor 110 can detect an advertised device identifier. After detecting an advertised device identifier, the method 400 can proceed to block 406.

At block 406, the detected advertised device identifier can be sent to a server. For example, the processor 110 sends the detected advertised device identifier to the server 108, such as an application server. After sending the detected advertised device identifier, the method 400 can proceed to block 408.

At block 408, the detected device identifier can be compared to one or more known device identifiers. For example, the server 108 can compare the detected advertised device identifier from the mobile device to one or more known device identifiers. For a matched device identifier, the method 400 can proceed to block 412. For an unmatched device identifier, the method 400 can proceed to block 410.

At block 410, the unmatched device identifier can be stored. For example, the server 108, e.g., the application server, can store the unmatched device identifier. The unmatched device identifier can be stored in the server 108, in an associated server or in one or more associated databases 120. After storing the unmatched device identifier, the method 400 can proceed to block 402.

At block 412, the matched device identifier can be stored and a notification can be issued to the mobile device. For example, the server 108 can store the matched device identifier and can issue or send a notification to the mobile device 102. The matched device identifier can be stored in the server 108, in an associated server or in one or more associated databases 120. In response to receiving the notification, the processor 110 of the mobile device 102 can issue the notification. The notification can be within the mobile device 102 at the operating system level and/or at the application level. The notification can result in a visual, audible and/or via vibrational notification depending on the settings of the mobile device 102. For example, in response to the issued notification, an application icon in an operating system level and/or in the application level can be displayed, a ring tone can be triggered and/or the mobile device can vibrate to inform the user of the matched device identifier. FIG. 22 shows a homepage 2200 displaying three notifications 2214, 2216, 2218 of three matched device identifiers. After storing the matched device identifier and issuing a notification, the method 400 can proceed to block 414.

At block 414, a selection of a category associated with a matched device identifier can be received. For example, in response to the application level notification, the processor 110 can render a list of user selected categories and the processor 110 can receive a selection of one of the displayed user selected categories. Referring to FIG. 22 again, the user can select one of the displayed user selected categories, such as the LA Auto Show category 2202. After receiving a selection of a category, the method 400 can proceed to block 416.

At block 416, a determination can be made whether the mobile device is connected to the internet. For example, the processor 110 determines if there is an internet connection. If the determination is that there is no internet connection, then the method 400 can proceed to block 418. If the determination is that there is an internet connection, then the method 400 can proceed to block 420.

At block 418, locally cached information associated with the selected category is rendered, if available. For example, the processor 110 determines if there is locally cached information associated with the selected category and renders such information if available.

FIG. 24 shows a header page 2400 displaying three headers 2402, 2404, 2406. In the event that the header page 2400 was stored in the local cache, then the header page 2400 could be displayed.

At block 420, header content associated with the device identifier can be downloaded and rendered. For example, the processor 110 can use the device identifier to download header content associated with the device identifier from a server 108 via the internet. Once the header content is downloaded, the processor 110 can render the header content. Again, FIG. 24 is a screenshot of an exemplary header page 2400. After downloading the content, the method 400 can proceed to block 422.

At block 422, additional content associated with the device identifier can be downloaded in response to receiving a selection of the previous downloaded content. For example, the processor 110 can download the content associated with the selected header and can display the additional content associated with the selected header. FIG. 26 shows a content page 2600 associated with the selected header 2404 of FIG. 24.

Referring to FIG. 5, a flowchart of a method for using content messaging at a point of purchase in accordance with an exemplary embodiment is illustrated. The exemplary method 500 is provided by way of example, as there are a variety of ways to carry out the method. The method 500 described below can be carried out using the components illustrated in FIG. 1 by way of example, and various elements of these figures are referenced in explaining exemplary method 500. Each block shown in FIG. 5 represents one or more processes, methods or subroutines, carried out in the exemplary method 500. The exemplary method 500 can begin at block 502.

At block 502, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 500 can proceed to block 504.

At block 504, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 500 can proceed to block 506.

At block 506, an advertised device identifier can be detected. For example, the processor 110 can detect an advertised device identifier. The advertised device identifier can be advertised by a wireless beaconing unit, e.g., a WiFi transmitter 104 and/or a Bluetooth transmitter 106, associated with a point of purchase device. The point of purchase device can be fixed, e.g., a cash register, or roaming, e.g., a mobile device enabled point of purchase. After detecting the advertised device identifier, the method 500 can proceed to block 508.

At block 508, a proximity notification can be sent. For example, the processor 110 can send a notification to the server 108, an application server. The proximity notification can indicate that the mobile device is within an acceptable proximity of a point of purchase device. After sending the proximity notification, the method 500 can proceed to block 510.

At block 510, a validation notification can be sent. For example, the server 108 can send a validation notification to one or more credit services corresponding to one or more financial instruments, e.g., credit cards and/or debit cards, associated with the mobile device 102. The validation notification can inform the credit service that the mobile device 102 is near a point of purchase device. The validation notification can include the detected device identifier associated with the point of purchase device. After sending the validation notification, the method 500 can proceed to block 512.

At block 512, the validation notification can be used. For example, the credit service can use the validation notification to validate, confirm the purchase, or further rate the risk of fraud as is generally understood by one of ordinary skill in the art. In other words, the validation notification can indicate that a specific financial instrument is being used at a specific location and that a mobile device associated with same financial instrument is also at the same location. As an non-limiting example, to encourage adoption of this method, credit issuers may urge utilization of variations of this methodology by adjusting various credit terms to users (merchants and/or credit/debit card users), including loyalty points, discount rates, redemption rates, interest rates, or any suitable combination.

Referring to FIG. 6, a flowchart of an alternate method for using content messaging at a point of purchase in accordance with an exemplary embodiment is illustrated. The exemplary method 600 is provided by way of example, as there are a variety of ways to carry out the method. The method 600 described below can be carried out using the components illustrated in FIG. 1 by way of example, and various elements of these figures are referenced in explaining exemplary method 600. Each block shown in FIG. 6 represents one or more processes, methods or subroutines, carried out in the exemplary method 600. The exemplary method 600 can begin at block 602.

At block 602, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 600 can proceed to block 604.

At block 604, the merchant can search for advertised device identifiers. For example, one or more point of purchase devices associated with a merchant can search for advertised device identifiers from mobile devices 102 in close proximity to the point of purchase device. For example, the merchant point of purchase device can be a mobile device or other device having a suitable transceiver for receiving/transmitting device identifiers appropriately adapted for use with the system 100. After searching for advertised device identifiers, the method 600 can proceed to block 606.

At block 606, an advertised device identifier can be detected and correlated to an individual. For example, one or more of the point of purchase devices associated with the merchant can detect an advertised device identifier from a mobile device 102 which is in close proximity to a point of purchase device and then correlate the advertised device identifier to an individual. The point of purchase device associated with the merchant can be fixed, e.g., a cash register, or roaming, e.g., a mobile device enabled point of purchase. After detecting the advertised device identifier and correlating to an individual, the method 600 can proceed to block 608.

At block 608, a proximity notification can be sent. For example, the point of purchase device associated with the merchant can send a notification to the server 108, an application server. The proximity notification can indicate that the mobile device is within an acceptable proximity of a point of purchase device associated with the merchant. After sending the proximity notification, the method 600 can proceed to block 610.

At block 610, a validation notification can be sent. For example, the server 108 can send a validation notification to one or more credit services corresponding to one or more financial instruments, e.g., credit cards and/or debit cards, associated with the mobile device 102. The validation notification can inform the credit service that the mobile device 102 is near a point of purchase device. The validation notification can include the detected device identifier associated with the point of purchase device. After sending the validation notification, the method 600 can proceed to block 612.

At block 612, the validation notification can be used. For example, the credit service can use the validation notification to validate or confirm the purchase. In other words, the validation notification can indicate that a specific financial instrument is being used at a specific location and that a mobile device associated with same financial instrument is also at the same location.

Referring to FIG. 7, a flowchart for a method for using content messaging for protecting property in accordance with an exemplary embodiment is illustrated. The exemplary method 700 is provided by way of example, as there are a variety of ways to carry out the method. The method 700 described below can be carried out using the components illustrated in FIG. 1 by way of example, and various elements of these figures are referenced in explaining exemplary method 700. Each block shown in FIG. 7 represents one or more processes, methods or subroutines, carried out in the exemplary method 700. The exemplary method 700 can begin at block 702.

At block 702, device identifiers and corresponding data can be downloaded. For example, the processor 110 of the mobile device 102 can download device identifiers and corresponding data from one or more servers 108. The number of device identifiers and corresponding data that is downloaded to the mobile device 102 can be limited. For example, the number of device identifiers and corresponding data can be limited based on one or more of the following: authorized user list, user account list, and/or registered objects. A registered object can be device identifiers that logged into the system 100 by a manufacturer or ser. After downloading the list of device identifiers and corresponding data, the method 700 can proceed to block 704.

At block 704, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 700 can proceed to block 706.

At block 706, an advertised device identifier can be detected and correlated. For example, the processor 110 can detect an advertised device identifier associated with a fixed product, such as a house, or a roaming product, such as a vehicle, and correlate the detected advertised device identifier to the product. The advertised device identifier can be advertised by a wireless beaconing unit 104, 106, e.g., a WiFi transmitter 104 and/or a Bluetooth transmitter 106, associated with the product. After detecting and correlating the advertised device identifier, the method 700 can proceed to block 708.

At block 708, a proximity notification can be sent. For example, the processor 110 can send a notification to the server 108, an application server. The proximity notification can indicate that the mobile device 102 is within an acceptable proximity of the product, e.g., house, vehicle or laptop. After sending the proximity notification, the method 700 can proceed to block 710.

At block 710, a validation notification can be sent. For example, the server 108 can send a validation notification to a security service associated with the product 102. The validation notification can inform the security service that the mobile device 102 is near the product, e.g., house or vehicle. The validation notification can include the detected device identifier associated with the product. The notification can be decided by the security company based on notification and validation. Alternatively, a notification may be issued to the mobile device for further action on the part of the user to confirm access credentials. Credentials may include any well-known validation sequences including challenges, personal identification number (PIN), password, fingerprint identification, gesture swiping, text-messaging, retina scan, facial recognition, etc.

Referring to FIG. 8, a flowchart of an alternate method for using content messaging for protecting property in accordance with an exemplary embodiment is illustrated. The exemplary method 800 is provided by way of example, as there are a variety of ways to carry out the method. The method 800 described below can be carried out using the components illustrated in FIG. 1 by way of example, and various elements of these figures are referenced in explaining exemplary method 800. Each block shown in FIG. 8 represents one or more processes, methods or subroutines, carried out in the exemplary method 800. The exemplary method 800 can begin at block 802.

At block 802, device identifiers and corresponding data can be downloaded. For example, the processor 110 of the mobile device 102 can download device identifiers and corresponding data from one or more servers 108. The number of device identifiers and corresponding data that is downloaded to the mobile device 102 can be limited. For example, the number of device identifiers and corresponding data can be limited based on one or more of the following: authorized user list or user account list. After downloading the list of device identifiers and corresponding data, the method 800 can proceed to block 804.

At block 804, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 800 can proceed to block 806.

At block 806, an advertised device identifier can be detected and correlated. For example, the processor 110 can detect an advertised device identifier associated with a fixed product, such as a house, or a roaming product, such as a vehicle, and correlate the detected advertised device identifier to the product. The advertised device identifier can be advertised by a wireless beaconing unit 104, 106, e.g., a WiFi transmitter 104 and/or a Bluetooth transmitter 106, associated with the product. After detecting and correlating the advertised device identifier, the method 800 can proceed to block 808.

At block 808, determine if the property recognizes the presence of the mobile device. For example, a device associated with the property, e.g., a vehicle, can determine if an advertised device identifier broadcasted by the mobile device is recognized. The device can receive the advertised device identifier, compare the identifier to one or more stored device identifiers and determine if there is a match. If there is no match, the method 800 can proceed to block 810. If there is a match, the method 800 can proceed to block 812.

At block 810, notify the owner and/or theft prevention service, if, without the notification, the vehicle is started and moved or the property is access or entered. For example, the server 108 can send a validation notification to one or more security or theft prevention services associated with the mobile device 102. In one or more embodiments, the user can associate property, such as one or more vehicles, with the user's mobile device 102. The validation notification can inform the one or more security or theft prevention services that the property was moved or entered without verification. After the notification, the method 800 can proceed to block 812.

At block 812, the validation can be logged. For example, the device associated with the property can send a notification to the server 108, e.g., application server, to log the event.

Referring to FIG. 9, a flowchart of a method for using double authentication to protect property in accordance with an exemplary embodiment is illustrated. The exemplary method 900 is provided by way of example, as there are a variety of ways to carry out the method. The method 900 described below can be carried out using the components illustrated in FIG. 1 by way of example, and various elements of these figures are referenced in explaining exemplary method 900. Each block shown in FIG. 9 represents one or more processes, methods or subroutines, carried out in the exemplary method 900. The exemplary method 900 can begin at block 902.

At block 902, device identifiers and corresponding data can be downloaded. For example, the processor 110 of the mobile device 102 can download device identifiers and corresponding data from one or more servers 108. The number of device identifiers and corresponding data that is downloaded to the mobile device 102 can be limited. For example, the number of device identifiers and corresponding data can be limited based on one or more of the following: authorized user list, user account list, and/or registered objects. A registered object can be device identifiers that logged into the system 100 by a manufacturer or user. After downloading the list of device identifiers and corresponding data, the method 900 can proceed to block 904.

At block 904, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 900 can proceed to block 906.

At block 906, determine if a detected advertised device identifier correlates to a known device identifier. For example, the processor 110 can detect an advertised device identifier associated with a product, such as a vehicle, and correlate the detected advertised device identifier to a known device identifier associated with the product. The advertised device identifier can be advertised by a wireless beaconing unit 104, 106, e.g., a WiFi transmitter 104 and/or a Bluetooth transmitter 106, associated with the product, e.g., the vehicle. If there is no match, the method 900 can proceed to block 908. If there is a match, the method 900 can proceed to block 910.

At block 908, an additional measure is required to start and/or operate the vehicle or access the property. The additional measure can be a physical key, a user pin or super user pin start or operate a vehicle or to access the property. For example, if there is no match between the detected advertised device identifier and a known device identifier associated with the property, a physical key or user pin can be required to access or operate the property. In other, the mobile device 102 can do nothing and the user will need to use traditional means to access or operate the property, e.g., vehicle.

At block 910, reduced security can be used to access or operate the property. For example, when there is a match, the processor 110 can notify a device associated with the property, e.g., the device that broadcasted the device identifier, that there is a match and the property can take action. The action can be unlocking the doors of a vehicle and/or allow the vehicle to be started without a key or electronic access to a property, e.g. electronic lock or disarming an alarm system.

Referring to FIG. 10, a flowchart of a method for discovery and content messaging in accordance with an exemplary embodiment is illustrated. The exemplary method 1000 is provided by way of example, as there are a variety of ways to carry out the method. The method 400 described below can be carried out using the components illustrated in FIG. 1 by way of example, and various elements of these figures are referenced in explaining exemplary method 1000. Each block shown in FIG. 10 represents one or more processes, methods or subroutines, carried out in the exemplary method 1000. The exemplary method 1000 can begin at block 1002.

At block 1002, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 1000 can proceed to block 1004.

At block 1004, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 1000 can proceed to block 1006.

At block 1006, a determination can be made whether the mobile device is connected to the internet. For example, the processor 110 determines if there is an internet connection. If there is no internet connection, then the method 1000 can proceed to block 1008. If the determination is that there is an internet connection, then the method 1000 can proceed to block 1010.

At block 1008, detect and correlate an advertised device identifier. For example, the processor 110 can detect an advertised device identifier and correlate the detected advertised device identifier to a fixed or roaming location within the system via passive discovery. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1000 can proceed to block 1010.

At block 1010, a token from the downloaded and corresponding data can be issued. For example, the processor 110 can issue e.g., notification, credit, unique opportunity or invitation available to the user's account. After issuing the token, the method 1000 can proceed to block 1012.

At block 1012, upon connection to the internet, a server or third party server can distribute tokens, awards, collects information and allows further interaction for content with the server based on location of areas discovered and collected. For example, the processor 110 can accept invitation to download unique opportunities/headers and additional content for the user to engage.

At block 1014, an advertised device identifier can be detected and correlated. For example, the processor 110 can detect an advertised device identifier and correlate the detected advertised device identifier to a fixed or roaming location within the system. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1000 can proceed to block 1016.

At block 1016, a proximity notification can be sent. For example, the processor 110 can send a notification to the server 108, an application server. The proximity notification can indicate that the mobile device is within an acceptable proximity of a fixed or roaming location. After sending the proximity notification, the method 1000 can proceed to block 1018.

At block 1018, a server or third party server can distribute tokens, awards, collects information and allows further interaction for content with the server based on location of areas discovered and collected. For example, the processor 110 can accept invitation to download unique opportunities/headers and additional content for the user to engage.

Referring to FIG. 11, a flowchart of a method for discovery and content messaging in accordance with an exemplary embodiment is illustrated. The exemplary method 1100 is provided by way of example, as there are a variety of ways to carry out the method. The method 1100 described below can be carried out using the components illustrated in FIG. 1 by way of example, and various elements of these figures are referenced in explaining exemplary method 1100. Each block shown in FIG. 11 represents one or more processes, methods or subroutines, carried out in the exemplary method 1100. The exemplary method 1100 can begin at block 1102.

At block 1102, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 1100 can proceed to block 1104.

At block 1104, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 1100 can proceed to block 1106.

At block 1106, an advertised device identifier can be detected and correlated to an individual. For example, the processor 110 can detect an advertised device identifier from a wireless beaconing unit, e.g., a mobile device and correlate the advertised device identifier to an individual. After detecting the advertised device identifier and correlating to an individual, the method 1100 can proceed to block 118.

At block 1108, a proximity notification can be sent. For example, the processor 110 can send a notification to the server 108, an application server. The proximity notification can indicate that the mobile device is within an acceptable proximity of a fixed or roaming location. After sending the proximity notification, the method 1100 can proceed to block 1110.

At block 1110, a server or third party server can distribute tokens, awards, collects information and allows further interaction for content with the server based on location of areas discovered and collected. For example, the processor 110 can issue a token, e.g. notification, credit, unique opportunity or invitation available to the user's account/mobile device.

The methods described in FIGS. 10 and 11 can be applied to a wide range of uses/scenarios. For example, attractions, such as amusement parks, ski resorts, museums, exhibits, sport venues, and any other location can use the described methods for various purposes. The attraction can place wireless beaconing units throughout their location for broadcasting and/or receiving device identifiers. The placements can be fixed or mobile. Based on the interactions between the wireless beaconing unit and mobile devices, data can be obtained and content can be accessed. For example, wireless beaconing unit can be placed at the beginning and end of lines, such as rides, food stands, chair lifts, exhibits, entrances, exits, and/or other locations to determine the time it takes for a mobile device to proceed through a line. The attraction can also use the data to provide content to the end users. For example, users can access a map, obtain a list of wait times for lines, such as rides, food stands, chair lifts, exhibits, entrances, exits, and/or other locations to determine the time it takes for a mobile device to proceed through a line. At a ski resort, skiers can use their mobile device to obtain weather reports. Similarly, the attractions can track end users for reward purposes. For example, an amusement park can provide rewards for riding a ride and/or riding different rides. The rewards can take various forms, such as points, discount tickets, and/or a special ticket such as a fast pass for a ride they have not taken. Similarly, a character associated with an amusement park can have a wireless beaconing unit with them to allow others to obtain their location using the mobile devices.

The methods described in FIGS. 10 and 11 can be applied to special events such as a convention. Wireless beaconing units can be located throughout the venue to track people within the convention, to offer materials associated with the convention, such as a presentation, a list of attendees with or without pictures of the attendees, notification when one attendee is near another attendee. In one or more embodiments, the wireless beaconing unit can be the mobile devices where two or more mobile devices are providing the content.

The methods described in FIGS. 10 and 11 can be applied to real estate. Wireless beaconing units can be located at a property for lease or sale, to offer materials associated with the property, such as a listing agent, photographs and additional content relevant to the property listed or associated properties. In one or more embodiments, the wireless beaconing units can be the mobile devices where two or more devices are providing the content.

The methods described in FIGS. 10 and 11 can be applied to academics, e.g. institutions were students attend classes. Wireless beaconing units can be located in the classroom to keep attendance records or send additional content to students registered for the class while in proximity. In one or more embodiments, the wireless beaconing units can be the mobile devices where two or more devices are providing the content.

The methods described in FIGS. 10 and 11 can be applied to transient services such as a mobile business, e.g. plumbers or servicemen. Wireless beaconing units can be located in the vehicle to offer materials associated with the business, such as a contact information, pictures and or additional online content. In one or more embodiments, the wireless beaconing units can be the mobile devices where two or more devices are providing the content.

The methods described in FIGS. 10 and 11 can be applied to independent artist, e.g., musicians, designers. Wireless beaconing units can be located on a person, in a venue or concert hall to offer materials associated with the artist, such as contact information, pictures and or additional online content. In one or more embodiments, the wireless beaconing units can be the mobile devices where two or more devices are providing the content.

The methods described in FIGS. 10 and 11 can be applied to personal branding, e.g., salesman or consultants. Wireless beaconing units can be on person or located at an event to offer materials associated with the person, such as a contact information, pictures and or additional online content. In one or more embodiments, the wireless beaconing units can be the mobile devices where two or more devices are providing the content.

The methods described in FIGS. 10 and 11 can be applied to pet identification, e.g., digital pet tags. Wireless beaconing units can be located on the pet to offer materials associated with the pet, such as owner contact information, pictures, lifestyle and health information and or additional online content. In one or more embodiments, the wireless beaconing units can be the mobile devices where two or more devices are providing the content.

The methods described in FIGS. 10 and 11 can be applied to sports related venues or collecting points, e.g., digital baseball cards. Wireless beaconing units can be located at sport venues acting as collection points for digital sports cards that contain photos, stats, and additional content. In one or more embodiments, the wireless beaconing units can be the mobile devices where two or more devices are providing the content.

The methods described in FIGS. 10 and 11 can be applied to gamification, e.g. online gaming. Wireless beaconing units can be located at real world locations, acting as collection points for tokens, prizes or keys to unlocking levels in social gaming. In one or more embodiments, the wireless beaconing units can be the mobile devices where two or more devices are providing the content.

The methods described in FIGS. 10 and 11 can be applied to VIPs. For example, upon determining the identity of an individual, further filtering of the individual is possible by combining the beacon-identity of an individual with external data. Consider that the beacon-identity of the individual can be further matched with a separate data set (database, address book, list or other identity collections) known to a person or entity. A cross-reference of the beacon-identity with other external data can further trigger a link to additional information for that user such as a photo display, list of personal preferences, identification of other known acquaintances, etc.

As a non-limiting example of correlating a beacon-identity with additional data (external from the system 100 or otherwise), consider a computer-connected display having local or centralized logic coupled to the beacon system 100. The computer-connected display is also coupled to a wireless beaconing unit for receiving beacons. As above in various methods, a beacon can be delivered such that the beacon-identity of an individual is made known.

In accordance with the beacon-identity, the computer-connected display can continuously receive all beacon-identities of individuals and displaying name or other data associated with such individuals. From time to time, a VIP may enter whereby the computer-connected display and associated logic locates a match between an entering individual having a beacon-identity and an existing VIP data set including beacon-identities as one part of such data set. The computer-connected display may receive a further notification via its local or central logic that the individual is a VIP and display additional data about this further selected individual.

Referring to FIG. 12, a flowchart of a method for server logging in accordance with an exemplary embodiment is illustrated. The exemplary method 1200 is provided by way of example, as there are a variety of ways to carry out the method. The method 1200 described below can be carried out using the components illustrated in FIG. 1 by way of example, and various elements of these figures are referenced in explaining exemplary method 1200. Each block shown in FIG. 12 represents one or more processes, methods or subroutines, carried out in the exemplary method 1200. The exemplary method 1200 can begin at block 1202.

At block 1202, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 1200 can proceed to block 1204.

At block 1204, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 1200 can proceed to block 1206.

At block 1206, a determination can be made whether the mobile device is connected to the internet. For example, the processor 110 determines if there is an internet connection. If there is no internet connection, then the method 1200 can proceed to block 1208. If there is an internet connection, then the method 1200 can proceed to block 1210.

At block 1208, an advertised device identifier can be detected and correlated. For example, the processor 110 can detect an advertised device identifier and correlate the detected advertised device identifier to a fixed or roaming location within the system via passive discovery. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1200 can proceed to block 1210.

At block 1210, a token from the downloaded and corresponding data can be issued. For example, the processor 110 can provide/render a notification that the mobile device 102 has left its home network and can benefit from a new database download/new area download. After issuing the token, the method 1200 can proceed to block 1212.

At block 1212, upon connection to the internet, visits can be distributed. For example, once connected to the internet, a server 108, or application server, can award a visit to the user associated with the mobile device.

At block 1214, an advertised device identifier can be detected and correlated. For example, the processor 110 can detect an advertised device identifier and correlate the detected advertised device identifier to a fixed or roaming location within the system. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1200 can proceed to block 1216.

At block 1216, a proximity notification can be sent. For example, the processor 110 can send a notification to the server 108, an application server. The proximity notification can indicate that the mobile device is within an acceptable proximity of a fixed or roaming location. After sending the proximity notification, the method 1200 can proceed to block 1218.

At block 1218, a server or third party server can log the visit. For example, the server 108 or application server, can record that the user associated with the mobile device was in proximity to a known location.

Referring to FIG. 13, a flowchart of an alternate method for server logging in accordance with an exemplary embodiment is illustrated. The exemplary method 1300 is provided by way of example, as there are a variety of ways to carry out the method. The method 1300 described below can be carried out using the components illustrated in FIG. 1 by way of example, and various elements of these figures are referenced in explaining exemplary method 1300. Each block shown in FIG. 13 represents one or more processes, methods or subroutines, carried out in the exemplary method 1300. The exemplary method 1300 can begin at block 1302.

At block 1302, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 1300 can proceed to block 1304.

At block 1304, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 1300 can proceed to block 1306.

At block 1306, a determination can be made whether the mobile device is connected to the internet. For example, the processor 110 determines if there is an internet connection. If the there is no internet connection, then the method 1300 can proceed to block 1308. If there is an internet connection, then the method 1300 can proceed to block 1310.

At block 1308, an advertised device identifier can be detected and correlated. For example, the processor 110 can detect an advertised device identifier and correlate the detected advertised device identifier to a fixed or roaming location within the system via passive discovery. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1300 can proceed to block 1310.

At block 1310, a token from the downloaded and corresponding data can be issued. For example, the processor 110 can provide/render a notification that the mobile device 102 has left its home network and can benefit from a new database download/new area download. After issuing the token, the method 1300 can proceed to block 1312.

At block 1312, upon connection to the internet, a proximity notification can be sent and a service can be notified for collection of property. For example, the processor 110 can send a notification to the server 108, an application server. The proximity notification can indicate that the mobile device is within an acceptable proximity of a fixed or roaming location. The server 108 or application server can notify a service for collection of property.

At block 1314, detect and correlate an advertised device identifier. For example, the processor 110 can detect an advertised device identifier and correlate the detected advertised device identifier to a fixed or roaming location within the system. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1300 can proceed to block 1316.

At block 1316, a proximity notification can be sent. For example, the processor 110 can send a notification to the server 108, an application server. The proximity notification can indicate that the mobile device is within an acceptable proximity of a fixed or roaming location. After sending the proximity notification, the method 1300 can proceed to block 1318.

At block 1318, a proximity notification can be sent and a service can be notified for collection of property. For example, the processor 110 can send a notification to the server 108 or application server. The proximity notification can indicate that the mobile device is within an acceptable proximity of a fixed or roaming location. The server 108 or application server can notify a service for collection of property. An associated photo for an individual collecting property may also be associated with such service involved with the collection of property to facilitate visual identification/confirmation of the correct individual.

Referring to FIG. 14, a flowchart of a method for rewarding customer loyalty in accordance with an exemplary embodiment is illustrated. The exemplary method 1400 is provided by way of example, as there are a variety of ways to carry out the method. The method 1400 described below can be carried out using the components illustrated in FIG. 1 by way of example, and various elements of these figures are referenced in explaining exemplary method 1400. Each block shown in FIG. 14 represents one or more processes, methods or subroutines, carried out in the exemplary method 1400. The exemplary method 1400 can begin at block 1402.

At block 1402, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 1400 can proceed to block 1404.

At block 1404, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 1400 can proceed to block 1406.

At block 1406, a determination can be made whether the mobile device is connected to the internet. For example, the processor 110 determines if there is an internet connection. If there is no internet connection, then the method 1400 can proceed to block 1408. If the there is an internet connection, then the method 1400 can proceed to block 1410.

At block 1408, an advertised device identifier can be detected and correlated. For example, the processor 110 can detect an advertised device identifier and correlate the detected advertised device identifier to a fixed or roaming location within the system via passive discovery. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1400 can proceed to block 1410.

At block 1410, a token from the downloaded and corresponding data can be issued. For example, the processor 110 can provide/render a notification to the mobile device of reward, opportunity or to take a streamlined action for more convenient service. After issuing the token, the method 1400 can proceed to block 1412.

At block 1412, upon connection to the internet, a proximity notification can be sent and a service can be notified for customer rewarding. For example, the processor 110 can send a notification to the server 108, an application server. The proximity notification can indicate that the mobile device is within an acceptable proximity of a fixed or roaming location and the user associated with the mobile device can receive a customer reward.

At block 1414, an advertised device identifier can be detected and correlated. For example, the processor 110 can detect an advertised device identifier and correlate the detected advertised device identifier to a fixed or roaming location within the system. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1400 can proceed to block 1416.

At block 1416, a proximity notification can be sent. For example, the processor 110 can send a notification to the server 108, an application server. The proximity notification can indicate that the mobile device is within an acceptable proximity of a fixed or roaming location. After sending the proximity notification, the method 1400 can proceed to block 1418.

At block 1418, a proximity notification can be sent and a service can be notified for customer rewarding. For example, the processor 110 can send a notification to the server 108, an application server. The proximity notification can indicate that the mobile device is within an acceptable proximity of a fixed or roaming location and the user associated with the mobile device can receive a customer reward.

The methods described in FIG. 14 can be applied to a wide range of uses/scenarios. For example, loyalty programs based on customer behavior or preferences and any other loyalty oriented task can use the described methods for various purposes. The service can place wireless beaconing units at their point of service. Based on the interactions between the wireless beaconing units and mobile devices, data can be obtained and content can be accessed. The services can track end users footfall for reward purposes. The rewards can take various forms, such as points, discounts, and/or a special upgrades.

Referring to FIG. 15, a flowchart for a method for product rental and return in accordance with an exemplary embodiment is illustrated. The exemplary method 1500 is provided by way of example, as there are a variety of ways to carry out the method. The method 1500 described below can be carried out using the components illustrated in FIG. 1 by way of example, and various elements of these figures are referenced in explaining exemplary method 1500. Each block shown in FIG. 15 represents one or more processes, methods or subroutines, carried out in the exemplary method 1500. The exemplary method 1500 can begin at block 1502.

At block 1502, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 1500 can proceed to block 1504.

At block 1504, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 1500 can proceed to block 1506.

At block 1506, a determination can be made whether the mobile device is connected to the internet. For example, the processor 110 determines if there is an internet connection. If the there is no internet connection, then the method 1500 can proceed to block 1508. If there is an internet connection, then the method 1500 can proceed to block 1510.

At block 1508, an advertised device identifier can be detected and correlated. For example, the processor 110 can detect an advertised device identifier and correlate the detected advertised device identifier to a fixed or roaming location within the system via passive discovery. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1500 can proceed to block 1510.

At block 1510, a token from the downloaded and corresponding data can be issued. For example, the processor 110 can send a notification to the mobile device to take a streamlined action for more convenient service. After issuing the token, the method 1500 can proceed to block 1512.

At block 1512, upon connection to the internet, a proximity notification can be sent and a service can be notified for product rental and return. For example, the processor 110 can send a notification to the server 108, an application server. The proximity notification can indicate that the mobile device is within an acceptable proximity of a fixed or roaming location. The server 108 or application server can notify a service that a rental or property was returned.

At block 1514, an advertised device identifier can be detected and correlated. For example, the processor 110 can detect an advertised device identifier and correlate the detected advertised device identifier to a fixed or roaming location within the system. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1500 can proceed to block 1516.

At block 1516, a proximity notification can be sent. For example, the processor 110 can send a notification to the server 108, an application server. The proximity notification can indicate that the mobile device is within an acceptable proximity of a fixed or roaming location. After sending the proximity notification, the method 1500 can proceed to block 1518.

At block 1518, a proximity notification can be sent and a service can be notified for product rental and return. For example, the processor 110 can send a notification to the server 108, an application server. The proximity notification can indicate that the mobile device is within an acceptable proximity of a fixed or roaming location. The server 108 or application server can notify a service that a rental or property was returned.

The method described in FIG. 15 can be applied to a wide range of uses/scenarios. For example, coat check, valet, bell hop, product rental and return and any other service oriented task can use the described methods for various purposes. The service can place wireless beaconing units at their point of service. Based on the interactions between the wireless beaconing units and mobile devices, data can be obtained and content can be accessed. For example, at time of rental, the user's mobile device registers the merchants beacon, uploads to the id, and sends the users information to the merchants cue. Upon return and within proximity, the user is highlighted within the merchants cue for quick, personable and efficient service. Similarly, the services can track end users for reward purposes. For example, rental service can provide rewards for multiple rentals within a given time. The rewards can take various forms, such as points, discounts, and/or special upgrades.

Referring to FIG. 16, a flowchart of a method for visit counting and timing in accordance with an exemplary embodiment is illustrated. The exemplary method 1500 is provided by way of example, as there are a variety of ways to carry out the method. The method 1600 described below can be carried out using the components illustrated in FIG. 1 by way of example, and various elements of these figures are referenced in explaining exemplary method 1600. Each block shown in FIG. 16 represents one or more processes, methods or subroutines, carried out in the exemplary method 1600. The exemplary method 1600 can begin at block 1602.

At block 1602, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 1600 can proceed to block 1604.

At block 1604, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 1600 can proceed to block 1606.

At block 1606, a determination can be made whether the mobile device is connected to the internet. For example, the processor 110 determines if there is an internet connection. If there is no internet connection, then the method 1600 can proceed to block 1608. If there is an internet connection, then the method 1600 can proceed to block 1610.

At block 1608, an advertised device identifier can be detected and correlated. For example, the processor 110 can detect an advertised device identifier and correlate the detected advertised device identifier to a fixed or roaming location within the system via passive discovery. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1600 can proceed to block 1610.

At block 1610, a token from the downloaded and corresponding data can be issued. For example, the processor 110 can provide/render a notification to the mobile device of reward, opportunity or to take a streamlined action for more convenient service. After issuing the token, the method 1600 can proceed to block 1612.

At block 1612, upon connection to the internet, a server or third party server can distribute tokens, awards, collects information and allows further interaction for content with the server based on location of areas discovered and collected. For example, the processor 110 can accept an invitation to download unique opportunities/headers and additional content for the user to engage. After connecting to the internet and taking an action, the method 1600 can proceed to block 1614.

At block 1614, in response to advertised device identifier no longer being detected, a notification can be sent. For example, when the mobile device is no longer within proximity to the fixed or roaming location, the processor 110 can send a notification to the server 108 or application server.

At block 1616, an advertised device identifier can be detected and correlated. For example, the processor 110 can detect an advertised device identifier and correlate the detected advertised device identifier to a fixed or roaming location within the system. The advertised device identifier can be advertised by a wireless beaconing unit 104, 106, e.g., a WiFi transmitter 104 and/or a Bluetooth transmitter 106, associated with the location. After detecting and correlating the advertised device identifier, the method 1600 can proceed to block 1618.

At block 1618, a proximity notification can be sent. For example, the processor 110 can send a notification to the server 108, an application server. The proximity notification can indicate that the mobile device is within an acceptable proximity of a fixed or roaming location. After sending the proximity notification, the method 1600 can proceed to block 1620.

At block 1620, a server or third party server can distribute tokens, awards, collects information and allows further interaction for content with the server based on location of areas discovered and collected. For example, the processor 110 can accept an invitation to download unique opportunities/headers and additional content for the user to engage. After taking an action, the method 1600 can proceed to block 1622.

At block 1622, in response to advertised device identifier no longer being detected, a notification can be sent. For example, when the mobile device is no longer within proximity to the fixed or roaming location, the processor 110 can send a notification to the server 108 or application server.

Referring to FIG. 17, a flowchart of an alternate method for counting and timing content messaging method in accordance with an exemplary embodiment is illustrated. The exemplary method 1700 is provided by way of example, as there are a variety of ways to carry out the method. The method 1700 described below can be carried out using the components illustrated in FIG. 1 by way of example, and various elements of these figures are referenced in explaining exemplary method 1700. Each block shown in FIG. 17 represents one or more processes, methods or subroutines, carried out in the exemplary method 1700. The exemplary method 1700 can begin at block 1702.

At block 1702, device identifiers and corresponding data can be downloaded. For example, the processor 110 of the mobile device 102 can download device identifiers and corresponding data from one or more servers 108. The corresponding data can include the category the device identifier is associated with and whether or not the device identifier was previously found by the user associated with the mobile device. The number of device identifiers and corresponding data that is downloaded to the mobile device 102 can be limited. For example, the number of device identifiers and corresponding data can be limited based on one or more of the following: content groups or categories, geographical locations, and events. To assist the user, the user can be presented with a list of predetermined content groups from which the user can select one or more content groups that the user is interested in receiving associated content. This selection can be done during a registration process. The selected content groups can be revised at a later time. The number of device identifiers can also be limited by geographical location. The user may select an area based upon their current location to limit the number of device identifiers and corresponding data that are downloaded. The user can also select an area that is outside their current location providing an additional limited list of device identifiers and corresponding data that are downloaded. After downloading the list of device identifiers and corresponding data, the method 1700 can proceed to block 1704.

At block 1704, the mobile device can search for advertised device identifiers. For example, the processor 110 can search for advertised device identifiers using one or more antennas, e.g., WiFi antenna 104 and/or Bluetooth antenna 106. After searching for advertised device identifiers, the method 1700 can proceed to block 1706.

At block 1706, an advertised device identifier can be detected and correlated to an individual. For example, the processor 110 can detect an advertised device identifier from a beacon, e.g., mobile device, associated with an individual. After detecting the advertised device identifier and correlating to an individual, the method 1700 can proceed to block 1708.

At block 1708, a proximity notification can be sent. For example, the processor 110 can send a notification to the server 108, an application server. The proximity notification can indicate that the mobile device is within an acceptable proximity of a fixed or roaming location. After sending the proximity notification, the method 1700 can proceed to block 1710.

At block 1710, a server or third party server can distribute tokens, awards, collects information and allows further interaction for content with the server based on location of areas discovered and collected. For example, the processor 110 can send a notification to the mobile device of reward, opportunity or to take a streamlined action for more convenient service, After taking an action, the method 1700 can proceed to block 1712.

At block 1712, in response to advertised device identifier no longer being detected, a notification can be sent. For example, when the mobile device is no longer within proximity to the fixed or roaming location, the processor 110 can send a notification to the server 108 or application server.

The methods described in FIGS. 16 and 17 can be applied to a wide range of uses/scenarios. For example, entertainment, e.g. movies, retail, and any other “in range” and “out of range” oriented tasks can use the described methods for various purposes. The service can place wireless beaconing units at their point of service. Based on the interactions between the wireless beaconing units and mobile devices, data can be obtained and content can be accessed. For example, at a movie theater, the user's mobile device registers the merchants beacon that are placed in each individual theater, the user's mobile device ID is uploads to the application server notifying the merchant of their proximity to the wireless beaconing unit. The merchant than logs their visit and send additional content, discounts to the user for engagement. Similarly, the merchant can track end users for reward purposes. For example, the movie theater can provide rewards for multiple visits or for visiting particular a theater or movie. These rewards can take various forms, such as points, discounts, and/or special upgrades.

The methods described in FIGS. 16 and 17 can be applied to the elderly or physically impaired. For example, the service or user can place wireless beaconing units around a residence. Based on the interactions between the wireless beaconing units and mobile devices, data can be obtained and content can be accessed. For example, an elderly person leaves their residence, the user's mobile device registers them as out of range of the wireless beaconing units. The elderly user's mobile device ID uploads to the application server notifying the service that they are out of range. The service logs the event and notifies third party application.

Referring to FIG. 18, a block diagram of a category selection screenshot in accordance with an exemplary embodiment is illustrated. As shown, a user can select categories 1802 of messages that they are interested in receiving. The category selections can be selected during registration or can be updated at a later time. Each category 1802 can be selected or deselected by a user, e.g., using selection buttons 1804. After a user selects or updates the user's selections, the user can save their selections, e.g., using a next selection button 1806.

Referring to FIG. 19, a category selection screenshot in accordance with an exemplary embodiment is illustrated. As shown, there are eight categories that can be chosen. The categories include: LA Auto Show 1902, Food 1904, Autos 1906, Real Estate 1908, Pets 1910, People 1912, Places 1914 and Movies 1916. In this example, the user has selected the LA Auto Show 1902, Food 1904, Autos 1906, Real Estate 1908, People 1912 and Places 1914. Once the categories are selected, the mobile device 102 can receive messages for each of the selected categories. For example, the user can save their selections using the next selection button 1918, e.g., the “start zinging!” button. The number of categories can include a minimum number of categories, e.g., a minimum of four (4).

Referring to FIG. 20, a block diagram of a homepage screenshot in accordance with an exemplary embodiment is illustrated. The homepage 2000 can display selected categories as well as notification of new matched device identifiers, special opportunities, confirmations, unique data updates and updates to collected content. For example, each selected category can include a category image 2002, a category title 2004, and a notification of new matched device identifiers 2006. The homepage 2000 can include a total notification 2008 which can indicate the total number of new matched device identifiers for all of the selected categories. The notification of new matched device identifiers can take various forms, such as an icon or a number of the new matched device identifiers. In one or more embodiments, a notification is not rendered for a category having no new matched device identifiers.

Referring to FIG. 21, a block diagram of a homepage screenshot with a displayed menu in accordance with an exemplary embodiment is illustrated. As shown, a menu 2102 with menu options can be displayed. The menu options can be content 2104, collection 2106 and settings 2108. In one or more embodiments more or less menu options can be displayed. The content menu option 2104, when selected can cause a list of category headers to be rendered. The collection menu option 2106, when selected can cause a list of collections to be rendered. The settings menu option 2110, when selected can allow a user to change application settings. The menu 2102 can be displayed in response to one or more commands, such as a menu icon 2110 being selected. A home page icon 2112 can also be displayed. When the home page icon 2112 is selected, the homepage 2100 can be displayed.

Referring to FIG. 22, a homepage screenshot with a displayed menu in accordance with an exemplary embodiment is illustrated. The homepage 2200 can display the selected categories as well as notification of new matched device identifiers. For example, the selected categories include the LA Auto Show 2202, Food 2204, Autos 2206, Real Estate 2208, People 2210 and Places 2212 categories. The LA Auto Show category 2202 has a notification 2214 of one new matched device identifier. Similarly, the Food category 2204 has one notification 2216 and the Autos category 2206 has one notification 2218. A menu 2220 is also displayed.

Referring to FIG. 23, a block diagram of a screenshot of a header page in accordance with an exemplary embodiment is illustrated. As shown, the header page 2300 can include one or more headers 2302. Each header 2302 can include one or more fields. For example, each header 2302 can include, but not limited to, a title 2304, location 2306, owner 2308, status 2310, time 2312, collect 2314, counter 2316 and tag 2318 fields. The title field 2304 can be the title associated with the content. The location field 2306 can be the city or place where the content originated. The owner field 2308 can be the owner associated with the content. The status field 2310 can be a comment associated with the content. The status field 2310 can be limited to space and/or characters. The time field 2312 can be when the advertised device identifier was discovered. The collect field 2314 can be a selection button that allows a user to collect the content. The counter field 2316 can be the number of times the content was collected. The tag field 2318 can provide an indication if the header is new. The header page 2300 can display a list of each of the selected categories 2320 and can include an “all” category 2322. The headers 2302 that are displayed can be based on a selected category 2320 or can be for all of the selected categories 2322. One of the categories can be a default selection. Each category can include a notification indicator 2324 which indicates the number of new matched device identifiers.

The header page can include a search feature 2326 and a filter feature 2328. The search feature 2326, when activated, allows the user to search for one or more entered keywords and search for the keywords in the headers. In one or more embodiments, the search can proceed among the title, status, short description, location and username. The filter feature 2328, when activated, allows the user to segregate the headers based on one or more filtering options. In one or more embodiments, the filtering options can include proximity, recent, popularity, name and blocked. The proximity option can order the headers based on location, e.g., closest to farthest. The recent option can order the headers chronologically, e.g., most recent to least recent. The popularity option can order the headers based on the number of likes and collections. The name option can order the headers alphabetically using the Title. The blocked option can only show blocked headers that have been blocked by the user.

Referring to FIG. 24 a screenshot of a header page in accordance with an exemplary embodiment. As shown, the header page 2400 has three headers 2402, 2404, 2406. The list of selected categories include notification indicators indicating that the All category 2408 includes three new headers, the Food category 2410 includes one new header, and the Auto category 2412 includes one new header. The first header 2402 is associated with the food category. The header includes an image of a tomato. The title 2414 is Ale Roma Cucina. The location 2416 is San Juan Capristano. The owner 2418 is Zoussy. The status 2420 is “Ale Roma Cucina The Real Italian Food Taste.” The time 2422 is “0 mins ago.” The second header 2404 is associated with the LA Car Show category. The image is a concept car. The title is Ener-G-Force Concept by Mercedes-benz. The location is Los Angeles. The owner is Tony Nuovo. The status is “Get your off-road on in style.” The time is “0 mins ago.” The third header 2406 is associated with the auto category. The image is an automobile. The title is Porsche 911 Turbo 2112. The location is Santa Monica, Calif. The owner is Ja. The status is “Muscle cars are my passion.” The time is “0 mins ago.”

Referring to FIG. 25, a block diagram of a screenshot of a content page in accordance with an exemplary embodiment is illustrated. As shown, the content page 2500 can include content or full content associated with a header. The content page 2500 can include a description feature 2502, a gallery feature 2504, and a links feature 2506. The description feature 2502, when selected, can display content and a description of the content associated with a selected header. The gallery feature 2504, when selected, can display a list of all available photos and videos associated with a selected header. For example, the list can include thumbnails of photos and videos. When a thumbnail is selected, content associated with the thumbnail will be displayed in the description mode, explained below. The links feature 2506, when selected can display a list of all available links associated with a selected header. For example, the list can include links for Facebook, Youtube, Twitter, Linkedin, Pinterest, Flickr, Google+ and custom URL. When a link is selected, an in-application browser can be used to allow access to the link and permit navigation.

The description feature of the content page 2500 can include fields, including but not limited to, an image 2508, social share buttons 2510, counter 2512, title 2514, status 2516, location 2518, owner 2520, last updated 2522, and description 2524 fields. The image field 2508 can include an image to be displayed with the content or a video to be displayed with the content. The social share buttons 2510 can include selection buttons for various social networks, and can include a like selection button and a Google+ selection button that allow users to share with their extended social networks. The counter field 2512 can be the number of times the content was collected. The title field 2514 can be the title associated with the content. The status field 2516 can be a comment associated with the content. The location field 2518 can be the city or place where the content originated. The owner field 2520 can be the owner associated with the content. The last updated field 2522 can be a timestamp of when the content was last updated. The description field 2524 can be the content and take various forms, such as text, video, audio, or any other suitable media.

Referring to FIG. 26, a screenshot of a content page in accordance with an exemplary embodiment is illustrated. As shown, the content page 2600 is in the description mode 2602. The counter 2612 is at thirteen, e.g., the content was added to collections thirteen times. The title 2614 is “Ener-G-Force Concept by Mercedes-benz”. The status 2616 is “Get your off-road on in style!” The location 2618 is Los Angeles. The owner 2620 is Tony Nuovo. The last update 2622 was Feb. 27, 2013 @ 8:09 PM. The description 2624 is “As an environmentally friendly SUV, the Ener-G-Force, which Mercedes-Benz is presenting in Los Angles as a design study, meets these requirements and would be fully capable of supporting police and emergency services in every corner of the world.”

Referring to FIG. 27, a block diagram of a screenshot of a collections page in accordance with an exemplary embodiment is illustrated. The collections page 2700 can include a notification bar 2702 having a category name section 2704 and a notification section 2706. In the category name section 2704 each of the selected categories and an “all” category can be displayed. One of the categories can be a default selection. Each category in the notification section 2706 can include a notification indicator which indicates the number of updated headers. The collections page 2700 can include one or more headers 2708 that have been collected. Each header 2708 can include one or more fields. For example, each header 2708 can include, but not limited to, a title 2710, location 2712, owner 2714, status 2716, time 2718, uncollect 2720, and counter 2722 fields. The title field 2710 can be the title associated with the content. The location field 2712 can be the city or place where the content originated. The owner field 2714 can be the owner associated with the content. The status field 2716 can be a comment associated with the content. The status field 2718 can be limited to space and/or characters. The time field 2718 can be when the advertised device identifier was discovered. The uncollect field 2720 can be a selection button that allows a user to uncollect the content and send the heard back to the categorized list, e.g., if the user no longer wants information updates from a collected header, the user may uncollect the content. The counter field 2724 can be the number of times the content was collected.

Referring to FIG. 28, a screenshot of a collections page in accordance with an exemplary embodiment is illustrated. The collections page 2800 has ten new headers 2802 with one new header 2804 in the LA Auto Show category. Three headers 2806 are shown. The first detailed header is associated with the LA Car Show category. The image is a concept car. The title 2810 is Ener-G-Force Concept by Mercedes-benz. The location 2812 is Los Angeles. The owner is 2814 is Tony Nuovo. The status 2816 is “Get your off-road on in style.” The time 2818 the header was collected was “0 mins ago.” The second header is associated with the people category. The image and title are Tony Robbins. The location is Los Angles, Calif. The owner is Tony Nuovo. The status is “Are you ready to live the Extraordinary life?” The time was “22 days ago.” The third header is associated with the people category. The image is a cartoon. The title is Gangnam Style. The location is Korea. The owner is Zouzzy. The status is Opa gangnam style.” The time was “31 days ago.” As shown, the collections page 2800 can include a date stamp indicating when the header was collected.

The various embodiments described above are provided by way of illustration only and should not be construed to limit the scope of the disclosure. For example, the principles herein apply not only to a smartphone device but to other devices capable of receiving communications such as a laptop computer. Those skilled in the art will readily recognize various modifications and changes that may be made to the principles described herein without following the example embodiments and applications illustrated and described herein, and without departing from the scope of the disclosure. cm What is claimed is:

1. A process implemented method operating on a processor of a mobile device, the method comprising:
detecting, by the processor, one or more advertised device identifiers;
comparing, by the processor, each detected device identifier with device identifiers stored on the mobile device;
triggering an event, by the processor, in the event one or more detected device identifiers match a stored device identifier.

2. The method of claim 1 wherein the detecting is passive detection.

3. The method of claim 1 wherein the device identifier is a media access control (MAC) address.

4. The method of claim 1 wherein the triggering an event further comprises:
requesting, by the processor, content associated with each matched device identifier from a server;
receiving, by the processor, the requested content; and
rendering, by the processor, the received content.
